(19) United States
(12) Patent Application Publication
(10) Pub. No.: US 2020/0293627 A1
(43) Pub. Date: Sep. 17, 2020

(54) METHOD AND APPARATUS FOR COMPOSITE LOAD CALIBRATION FOR A POWER SYSTEM

(71) Applicant: General Electric Company, Schenectady, NY (US)

(72) Inventors: Honggang WANG, Clifton Park, NY (US); Manu PARASHAR, Redmond, WA (US)

(21) Appl. No.: 16/559,237

(22) Filed: Sep. 3, 2019

Related U.S. Application Data
(60) Provisional application No. 62/817,906, filed on Mar. 13, 2019.

(51) Int. Cl. G06F 17/50

(52) U.S. Cl. CPC G06F 17/5009

(57) ABSTRACT

Briefly, embodiments are directed to a system, method, and article for generating a power system load model of a power system. Power grid disturbance data may be accessed. A power system simulation engine may be prepared, wherein the simulation engine may implement the power system model of the power system. A parameter subset A may be identified from a knowledge-based approach. The parameter subset B may be identified based on a special grid event type based on the power grid disturbance data. A final parameter subset may be selectively determined based on parameter subsets A and B using a decision-making approach. At least one parameter of the final parameter subset may be tuned. One or more parameters of the power system load model may be modified based on the tuning.

### CROSS-REFERENCE TO RELATED APPLICATIONS

The present application claims the benefit of U.S. Provisional Patent Application No. 62/817,906 entitled “COMPOSITE LOAD MODEL CALIBRATION CONSIDERING FAULT-INDUCED DELAYED VOLTAGE RECOVERY (FIDVR) EVENTS” and filed on Mar. 13, 2019. The entire content of that application is incorporated herein by reference.

### BACKGROUND

A power system may be modeled for simulation and analysis in order to plan and operate a real-world implementation of the power system. Simulation and analysis may utilize a mathematical model of a power system which may include many inter-related linear/nonlinear differential and algebraic equations, for example. Such a model may also be utilized for the design of globally coordinated controllers to improve power system dynamic performance and stability, for example.

Power system dynamic model calibration is relatively important for power systems such as Positive Sequence Load Flow™ (PSLF), Power System Simulation for Engineering™ (PSS/E), Transient Simulation™ (TSAT), and/or a Powerworld™ software module, to name just a few examples. For example, during the 1996 Western System Coordinating Council™ (WSCC) blackout, planning studies conducted using dynamic models had predicted stable system operation of a real-world power system, whereas the real-world power system actually became unstable in a few minutes with severe swings. Understanding loads may be particularly crucial when power systems are operated closer to their stability limits. A load may comprise devices in a power system that consume electrical energy such as, for example, motors, lamps, office equipment, home appliances and so on. A Fault-Induced Delayed Voltage Recovery (FIDVR) event may comprise a slow voltage recovery after low-voltage faults mainly caused by the stalling of low-inertia single-phase industrial motors. FIDVR events are of increasing concern to utilities because of a resultant loss of voltage control and potential cascading effects, and associated costs, for example.

Load modeling for a power system may comprise two main steps: (a) selecting a load model structure; and (b) identifying the load model parameter using either component-based or measurement-based approach. There are generally three major types of load model structures: (a) a static load model including a Zero-inflated Poisson (ZIP) model, exponential model, and/or a frequency dependent model; (b) dynamic load models such as induction motor model; and (c) a composite load model, such as ZIP+ Induction Motor (IM) model, Complex load model (CLOD), and the most comprehensive WECC composite load model (CMPLDW) in a PSLF simulation software. The ZIP model, for example, may represent a relationship between the voltage magnitude and power in a polynomial equation that combines constant impedance (Z), current (I), and power (P) components.

Two approaches have been widely considered in order to derive load model parameters for a model calibration approach, e.g., component-based and measurement-based approaches. A component-based approach may comprise a “bottom-up” approach, where parameter estimation may be performed by aggregating a load at different levels. Such a process may require information regarding a load inventory, e.g., knowledge of a load composition and the load's electrical characteristics.

A measurement-based modeling approach, for example, may collect measurements from data acquisition equipment to derive load characteristics. Such an approach may obtain data from the actual network and may be applied to any load. It has been shown, for example, that aggregate active and reactive power characteristics may be closely related to load components and their characteristics. In addition, aggregate reactive power has been found to be highly voltage sensitive, therefore compensating capacitors and distribution transformers in the underlying network may also be accounted for.

The Western Electricity Coordinating Council™ (WECC) composite load model (CMPLDW) is a model which may represent FIDVR events, which may be of increasing concern to electric utilities. However, model nonlinearity and a large number of parameters (e.g., 121 parameters) of the CMPLDW model may pose severe identifiability issues and performance degradation for the measurement-based load modeling approach. For example, dependency of some model parameters implies they cannot be uniquely identified using the input-output measurements. Even though a parameter identifiability analysis may be an effective way to screen and reduce the number of parameters, this analysis suffers from a dependency of an initial parameter value and also a selection of sensitivity threshold.

### SUMMARY

According to an aspect of an example embodiment, a method may include generating a power system load model of a power system. Power grid disturbance data may be accessed. A power system simulation engine may be prepared, wherein the simulation engine may implement the power system model of the power system. A parameter subset A may be identified from a knowledge-based approach. The parameter subset B may be identified based on a special grid event type based on the power grid disturbance data. A final parameter subset may be selectively determined based on parameter subsets A and B using a decision-making approach. At least one parameter of the final parameter subset may be tuned. One or more parameters of the power system load model may be modified based on the tuning.

According to an aspect of another example embodiment, a system may include a receiver to receive power grid disturbance data. A power system simulation engine may implement a power system load model of a power system. A processor may identify a parameter subset A from a knowledge-based approach. The processor may also identify a parameter subset B based on a special grid event type based on the power grid disturbance data. The processor may further selectively determine a final parameter subset based on parameter subsets A and B using a decision-making approach. The processor may additionally tune at least one parameter of the final parameter subset. The processor may also modify one or more parameters of the power system load model based on the tuning.

According to an aspect of another example embodiment, an article may comprise a non-transitory storage medium comprising machine-readable instructions executable by one or more processors. The instructions may be executable to access power grid disturbance data and prepare a power system simulation engine. The simulation engine may implement the power system load model of the power system. The instructions may be further executable to identify a parameter subset A from a knowledge-based approach and identify the parameter subset B based on a special grid event type based on the power grid disturbance data. The instructions may also be executable to selectively determine a final parameter subset based on parameter subsets A and B using a decision-making approach. The instructions may additionally be executable to tune at least one parameter of the final parameter subset. The instructions may also be executable to modify one or more parameters of the power system load model based on the tuning.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 illustrates an embodiment of a power distribution grid.

FIG. 2 illustrates an embodiment of a delayed voltage recovery profile on an electrical power grid circuit.

FIG. 3 is a schematic diagram of an exemplary load model according to an embodiment.

FIG. 4 illustrates an embodiment of model calibration algorithms.

FIG. 5 illustrates a general framework of a process for power system model parameter conditioning according to some embodiments.

FIG. 6 illustrates a block diagram of an embodiment model calibration process for a two-stage approach.

FIG. 7 illustrates candidate parameter estimation algorithms according to an embodiment.

FIG. 8 is a block diagram of an embodiment a system for modeling one or more dynamic devices of an electric power system.

FIG. 9 illustrates a power grid system including an Enhanced Disturbance Management (EDM) component in accordance with an example embodiment.

FIG. 10 is an embodiment of a block diagram of an automatic load model calibration process.

FIG. 11 is an embodiment of a block diagram of an automatic load model calibration process which includes an offline evaluation and an online application.

FIG. 12 depicts a system which includes a power system model parameter conditioning tool in accordance an embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

One or more embodiments, as discussed herein, generally comprise a model validation/calibration tool for improving models of dynamic devices such as, for example, generation plants, renewable energy sources, control devices, and/or dynamic loads, in electric power systems. As more Phasor Measurement Units (PMUs) and disturbance recorder are installed in electric power systems, an abundance of high-fidelity disturbance measurement data may provide for relatively higher observability of dynamic behavior.

A “Phasor Measurement Unit” or “PMU,” as used herein refers to a device used to estimate the magnitude and phase angle of an electrical phasor quantity (such as voltage or current) in an electricity grid using a common time source for synchronization. Time synchronization may be provided by Global Positioning System (GPS) coordinates and may allow for synchronized real-time measurements of multiple remote points on an electricity grid. PMUs may be capable of capturing samples from a waveform in quick succession and reconstructing a phasor quantity, made up of an angle measurement and a magnitude measurement, for example. A resulting measurement is known as a “synchrophasor.” Such time synchronized measurements may be monitored, for example, because if an electricity grid's supply and demand are not perfectly matched, frequency imbalances may cause stress on the electricity grid, potentially resulting in power outages.

PMUs may also be used to measure a frequency in an electricity power grid. A typical commercial PMU may report measurements with very high temporal resolution in the order of 30-60 measurements per second, for example. Such measurements may assist engineers in analyzing dynamic events in the electricity grid which may not be possible with traditional Supervisory Control and Data Acquisition (SCADA) measurements which generate one measurement every 2 or 4 seconds. PMUs may therefore equip utilities with enhanced monitoring and control capabilities and are considered to be one of important measuring devices in the future of power systems. A system may include one or more receivers or transceivers, for example, to receive signals comprising measurements or parameters from one or more PMUs.

Embodiments as discussed herein may leverage data from grid disturbances to provide improved model accuracy to meet North American Electric Reliability Corporation (NERC) mandated grid reliability requirements, for example. A model calibration framework in accordance with one or more embodiments may be useful to alleviate a drawback of parameter identifiability. Such a model calibration framework may also be beneficial to explicitly handle an FIDVR event. An “FIDVR event,” as used herein, refers to an unexpected delay in the recovery of voltage to its nominal value following the normal clearing of a fault. An FIDVR event may comprise a slow voltage recovery after low-voltage faults which may be mainly caused by the stalling of low-inertia single-phase industrial motors, for example. For example, an FIDVR event may comprise a low voltage condition initiated by a transmission or distribution fault. For example, after fault clearing, an initial voltage recovery may be observed to less than 90 percent of pre-contingency voltage, followed by a slow voltage recovery, taking many seconds, to return to the pre-contingency voltage level, which may be accompanied by an over-voltage condition. Under normal conditions voltage recovers to nominal levels less than one second after the fault is cleared. A voltage recovery may be delayed for more than 30 seconds in a FIDVR event. An explicit incorporation of a FIDVR event feature in an embodiment as discussed herein may enhance a quality of identified model parameters, for example, by overcoming a drawback of a trajectory sensitivity approach. A generic framework may render an embodiment production grade ready to extend from existing generator model calibration to load model calibration. For example, load modeling is very stochastic and intermittent and may be more variable than in a generator model.

One or more embodiments may provide various technical advantages. For example, because a tool in accordance with an embodiment relies on disturbance data and does not need to take a component offline, the tool may provide a non-invasive solution and therefore does not result in any interruption of electrical grid operations. Additionally, explicit incorporation of an FIDVR event feature may enhance quality of identified model parameters, for example, by overcoming drawbacks of a trajectory sensitivity approach. A generic framework may make such a tool production-grade ready to extend from existing generator model calibration to load model calibration.

A software tool comprising an FIDVR event feature may provide commercial advantages. For example, such a software tool may be sold as an add-on to a Wide Area Monitoring System (WAMS) engineering analysis application suite. A model validation/calibration software tool may improve the models of dynamic devices (e.g., generation plants, renewable energy sources, control devices, dynamic loads, etc.) in electric power systems. Additionally, such a software tool may be sold as an add-on a PSLF software simulation tool. As more PMUs and disturbance recorder are installed, an abundance of high-fidelity disturbance measurement data provides a higher observability of dynamic behavior. Utility companies may have a need for such commercial software tools for model validation/calibration and as NERC begins to mandate this on a more stringent basis, the need for such a software tool is urgent. An embodiment may leverage measurements or data from grid disturbances for better model accuracy to meet NERC mandated grid reliability requirements, for example. One or one or more parameters of a real-world power system may be based on a power system model.

Power Grid planning and operating decisions rely on simulations of dynamic behavior of the power system. Both technical and commercial segments of the industry must be confident that the simulation models and database are accurate and up to date. If the transfer limits are set using overly optimistic models, a grid operator may unknowingly operate the system beyond its capability, thereby increasing the risk of widespread outages, such as occurred during summer 1996 power outages. If the models are pessimistic, a grid operator may be overly conservative and impose unnecessary restrictions on the transfer paths, thereby unnecessarily raising electricity costs or increasing the risk of power shortages in energy deficient regions. Therefore, having realistic load models is very important to ensure reliable and economic power system operation.

A PMU-based automatic load modeling system as discussed herein with respect to one or more embodiments may include trajectory sensitivities-based parameter screening, a FIDVR event-based parameter screening, a decision fusion module for parameter fusion and a parameter estimation module, for example. An explicit incorporation of an FIDVR event feature may enhance a quality of identified model parameters, e.g., by overcoming a drawback of a trajectory sensitivity approach. A generic framework may make a software tool production-grade ready to extend from existing generator model calibration to load model calibration. Such a software tool may also provide various commercial advantages. For example, such a software tool may be utilized with synchrophasor applications.

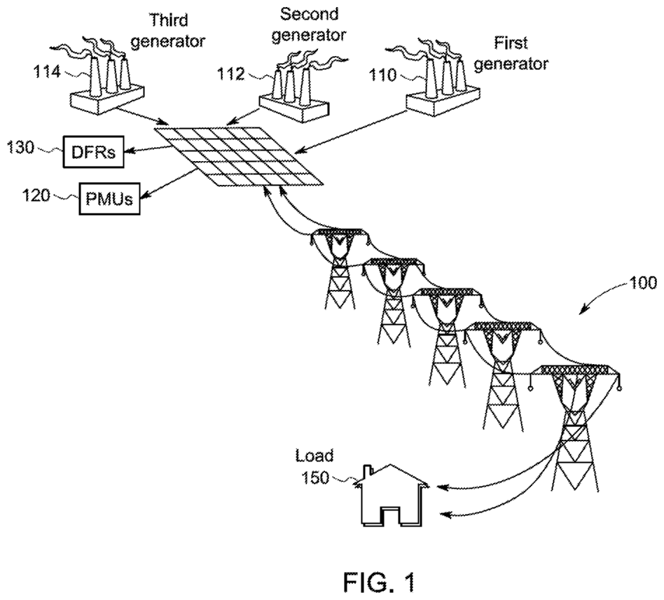

FIG. 1 illustrates an embodiment 100 of a power distribution grid. The grid of embodiment 100 may include a number of components, such as one or more power generators, for example, a first generator 110, second generator 112, and/or third generator 114, to name just a few examples. Although only three generators are shown in FIG. 1, it should be appreciated that more or fewer than three generators may be utilized in accordance with an embodiment. The grid of embodiment 100 may include transmission networks, transmitting electrons from power generator to the substations and distribution networks, transmitting electrons from the substations to the various loads, such as load 150. Although only a single load 150 is illustrated in FIG. 1, it should be appreciated that numerous loads may draw power from the power distribution grid in accordance with an embodiment.

The composition and utilization of end-use loads is continually evolving based on technological advances and economics. Historically, the load may comprise primarily of resistive heating, cooking, and lighting (e.g., incandescent) loads along with small single-phase induction motor loads driving small appliances and some residential air-conditioners. Today, these loads are rapidly disappearing for more advanced and higher efficiency end-use loads. Many of these loads include power electronic converters that convert alternating current (AC) to direct current (DC). Examples of these loads include cell phones, tablet computing devices, televisions, and other consumer electronic products. In addition, electric vehicles, distributed energy resources such as rooftop photovoltaic (PV) and battery storage system are becoming growing components of the end-use loads. Furthermore, for larger 3-phase and smaller 1-phase motor loads, more efficient Variable Frequency Drives are gradually replacing old-fashioned direct drives. As the characteristics of these loads is changing, the mathematic models describing the aggregated load may need to be updated accordingly.

In some cases, planning studies conducted using dynamic models may predict stable grid operation, whereas the actual grid of embodiment 100 may become unstable in a few minutes with severe swings (e.g., resulting in a massive blackout). To ensure that models represent the real-world system of embodiment 100 accurately, NERC developed several Modeling, Data, and Analysis (MOD) standards to ensure the model for both component level and system level are accurate and up to date. The component model validation may comprise of generator model, load model and High Voltage Direct Current (HVDC) models. System wide model validation may require comparison of system wide power flow simulation with time-synchronized recordings of bus voltage, angles and key paths flow, for example. For example, MOD-025 is to ensure that accurate information on generator gross and net Real and Reactive Power capability and synchronous condenser Reactive Power capability is available for planning models used to assess Bulk Electric System (BES) reliability. MOD-026 requires power plant owners to verify that the provided dynamic models of excitation controls are accurate and up to date. MOD-027 requires power plant owners to verify that the provided dynamic models of governors and turbine controls are accurate and up to date. On the system wide aspect, MOD-032-1 in conjunction with MOD-033-1 are related to system-level modeling and validation. Reliability Standard MOD-032-1 requires data submission by applicable data owners. Standard MOD-033-1 requires each Planning Coordinator to implement a documented process to perform model validation within its planning area. Recently, PMUs 120 and Digital Fault Recorders (“DFRs”) 130 have seen a dramatic increase in installation in recent years, which may allow for non-invasive model validation by using sub-second-resolution dynamic data. For example, PMUs 120 and/or DFRs 130 may receive various signals and/or make measurements of such signals from a power grid of embodiment 100. Varying types of disturbances across locations in the grid of embodiment 100 along with a relatively large installed base of PMUs 120 may, according to some embodiments, make it possible to validate dynamic models of generators, such as first generator 110, and loads, such as load 150, relatively frequently and at and different operating conditions, for example.

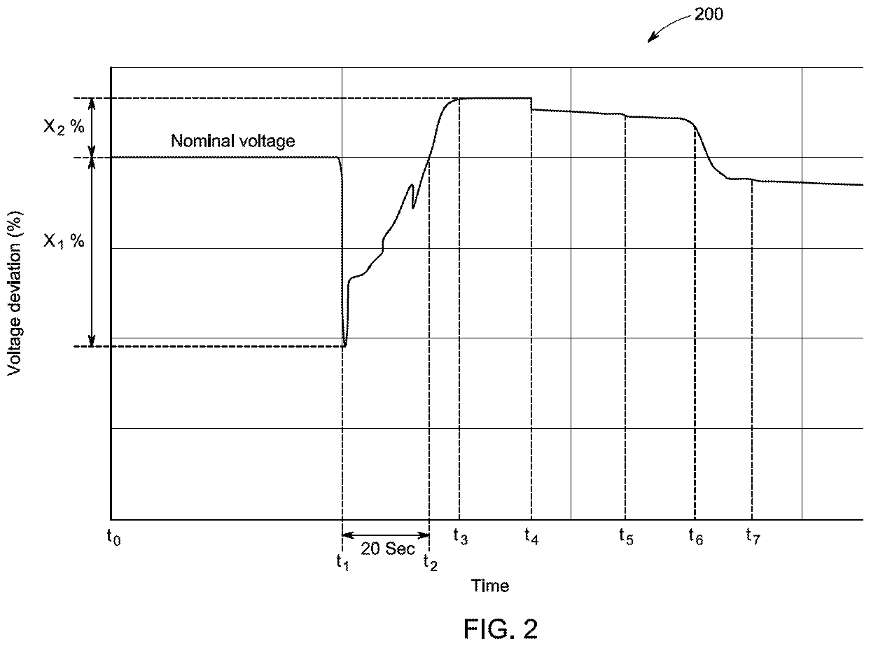

FIG. 2 illustrates an embodiment 200 of a delayed voltage recovery profile on an electrical power grid circuit. For example, embodiment 200 shows a voltage recovery profile where an FIDVR event has occurred. In an embodiment, an electrical power grid circuit may comprise a radial distribution circuit. For example, the electrical power grid circuit may comprise a 220 KV circuit. As illustrated in embodiment 200, an electrical power grid circuit may output a nominal voltage starting at time t₀ until a fault is experienced at about time t₁. As shown, during the fault incurred at around time t₁, an output voltage may decrease or deviate from the nominal voltage be a certain percentage, shown as X₁% in embodiment 200. In one particular embodiment, X₁% may comprise a deviation of about −21% from nominal voltage, or a value of about 79% of the nominal voltage, for example. Shortly after time t₁, the experienced fault may be cleared. For example, with an output voltage provided by the electrical power grid circuit being much lower than the nominal voltage, for example, this dip in output voltage may cause devices on the grid to reduce their electrical use. For example, devices such as air conditioning units may stall such that the stalled air conditioning units keep the output voltage shown in embodiment 200 from immediately recovering to the nominal voltage level. As shown in embodiment 200, an output voltage from the electrical power grid circuit in this example does not recover to the nominal voltage until time t₂. However, in this example, the output voltage overshoots the nominal voltage, continuing to increase until time t₃ in an overvoltage condition. For example, in an implementation where air conditioning units are drawing electrical power, when the air conditioner units' thermal overload protection switches are tripped, the output voltage from the electrical power grid circuit recovers, but overshoots the nominal voltage, by a value of X₂% as illustrated in embodiment 200 of FIG. 2. In this example, the overshoot may comprise a value of 6% greater than the nominal voltage. In this example embodiment, capacitor banks may still be connected to the electrical power grid circuit while an over-voltage occurred (e.g., between times t₂ and t₃), and this overvoltage condition may cause another issue or problem, resulting in capacitor banks tripping off, e.g., at times t₄ and t₅. In this example embodiment, with the capacitors tripped off and a load (e.g., including air conditioners) returning, the output voltage may fall below the nominal voltage, e.g., at times t₆ and t₇ shown in FIG. 2, thus making the electrical power grid circuit more vulnerable to other similar chains of events.

An FIDVR event may occur in certain conditions. For example, such conditions may include power factors reflecting a relatively high ratio of inductive loads to resistive loads. Such a load profile or conditions may be created, for example, by a relatively large number of motors or other types of inductive loads drawing power. Residential air conditioners may present such a load profile. Inertial constants of small motors may be small (e.g., typically less than 40 milliseconds), and accordingly, may stall in response to relatively small voltage fluctuations. As such, it has been observed that faults cleared in as little as 50 milliseconds (e.g., 3 cycles in a system with a nominal frequency of 60 Hz) may cause widespread stalling.

Once a motor is stalled, e.g., current flowing through the motor may increase dramatically. The additional current flow may lead to a temperature increase until a thermal cutoff threshold is reached, and further current flow is interrupted. After the thermal threshold is exceeded and additional current flow is cut off, the temperature of the device may begin to decrease. Once the device has cooled, the device may resume normal operation. As a result of the time lapse needed for the individual air conditioning systems to reach the thermal threshold and to cool down after reaching the thermal threshold, the voltage of an electric distribution system may remain depressed for an extended period of time (e.g., potentially several minutes of time). While an output voltage in the system is depressed, the system may face an increased risk of blackout.

Under typical conditions voltage may recover to nominal levels less than one second after a fault is cleared, but over the past few years there have been several instances at some substations, such as those of South California Edison™ (SCE), for example, where voltage recovery has been delayed for more than 30 seconds after a normal fault clearing. Such events have been observed to primarily occur during a heavy summer load at substations located in hot climates and which were serving new housing developments. Stalling air conditioner units are believed to be a primary cause of delayed voltage recoveries.

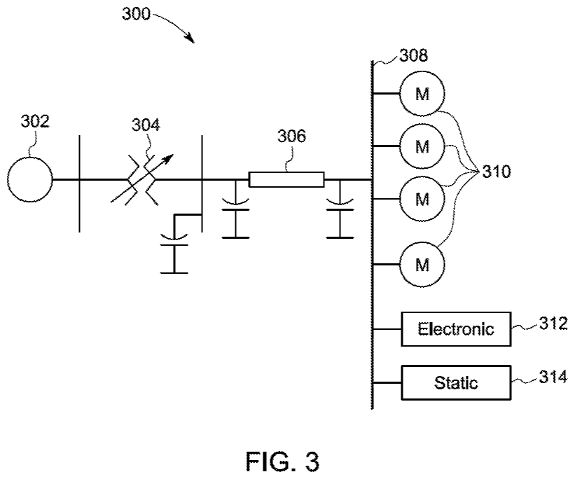

FIG. 3 is a schematic diagram of an exemplary load model 300 according to an embodiment. For example, load model 300 may be defined by Western Electricity Coordinating Council™ (WECC). WECC is a regional entity responsible for coordinating and promoting bulk electric system reliability in the Western Interconnection of North America. A functional electric network or a load model, as prescribed by the WECC, includes a generating station, transmission substations, and connected electric loads. To enable power generation corporations and electric grid operators in electrical network analysis of networks such as the network/load model 300, WECC developed models for transmission sub-stations, and distribution loads. Load model 300 may include a source 302 coupled to a plurality of items of transmission equipment. The transmission equipment may include a transformer 304, feeder line 306, and a power bus 308, to name just a few examples among many. In load model 300, multiple electric model loads may be coupled to power bus 308.

Electric loads that are coupled to the power bus 308 include, but are not limited to, appliances, machines, electronic components, and the like. The electric model loads may include motor model loads 310, electronic model load 312, and static model load 314, for example. Multiple appliances and machines may be represented in the form of motor model loads 310. For example, motor model loads 310 may represent constant-power loads (e.g., switching power supplies, induction motors or constant impedance loads, such as incandescent lighting and resistance heating (e.g., dryers, baseboard heaters, stoves, hot water heaters)). Each component of the load model 300 may be described by a plurality of parameters. For example, transformer 304 may be described by parameters such as minimum low-side voltage, maximum low-side voltage, step of a tap in a tap-changing transformer, and the like. Parameters, such as motor loading factor, stator resistance, electronic load power factor, and inertia constant among others, may be used to define the electric model loads 310, 312, and 314, for example.

Values for each parameter for each component may be varied to create a repository of different variations in the components of load model 300. Different model load types may be defined based on the parameters which describe the electric model loads 310, 312, and 314 in load model 300. For example, by varying motor loading factor iteratively, multiple motor model variations for motor model load 310 may be defined. A combination of such variations of motor model loads may be selected to simulate motor model loads 310 from the load model 300. Further, for each combination, a contribution factor may also be selected for each motor model load 310 to accurately represent the coupled actual motor model loads. A combination of model loads may comprise a mathematical representation of a relationship between input provided by the power source and all electric loads coupled to the power bus of the electric network. Each combination may be further defined by a contribution factor associated with each model load in the combination. A contribution factor may define a contribution of a particular model load in defining all electric load coupled to the power bus 308, for example.

A power system simulation engine may be utilized to model a power system in accordance with one or more embodiments. For example, a power system simulation engine may be represented by an Ordinary Differential Equation (ODE) model:

\dot{x}×f(x, u, p)

y=h(x, p), [Relation 1]

where x, u, p, and y comprise state, input, parameters, and outputs, respectively. In a playback mode, recorded excitation or input data u such as voltage and frequency may be provided to an ODE/Differential-algebraic equation (DAE) model of a power system component and the model response or output y such as real and reactive power may be computed. A goal is to seek a procedure to determine a set of parameters p such that a playback simulation of the model when excited with measured input data um, produces a simulated response that is close in some sense to the recorded response ym.

As between state estimation and optimization-based formulations, a typical approach is to treat model parameters p as state variables so as to cast the goal as a standard nonlinear state estimation goal, e.g., where w is process noise that accounts for input noise and model mismatch, and v is the measurement noise:

$$( \begin{matrix}\dot{p} \\ x\end{matrix} ) = ( \begin{matrix}0 \\ f ( x , u , p )\end{matrix} ) + w \\ y = h ( x , p ) = v , \qquad [ Relation 2 ]$$

To solve the nonlinear estimation goal shown in Relation 2, particle filtering, extended, ensemble, and/or unscented Kalman filtering approaches may be used. A drawback to solve a joint parameter and state estimation goal is that it may require excessive information exchange with a simulation engine. Such an invasive requirement may pose an engineering burden on existing simulation engines by requiring them to alter established data flows, for example. Moreover, such changes may need to be made on a model-by-model basis, which may further multiply an already significant engineering effort needed in order to make a generic model calibration tool.

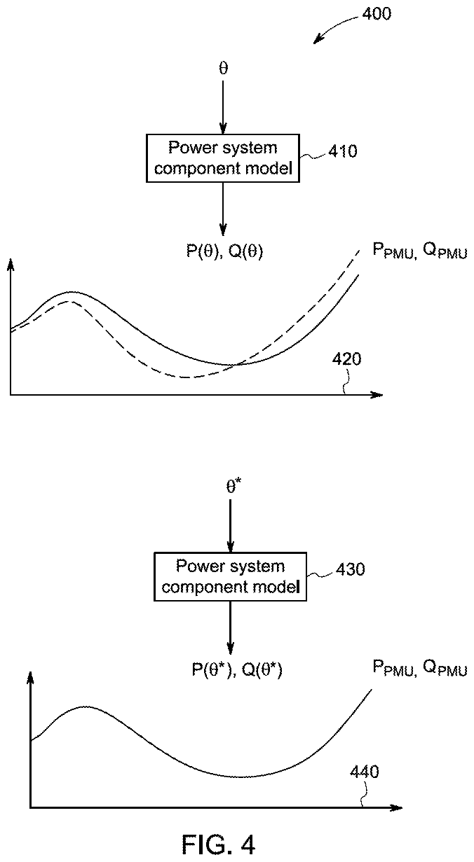

FIG. 4 illustrates an embodiment 400 of model calibration algorithms. In particular, a first power system component model 410 may receive parameter set θ and generate P(θ), Q(θ) as illustrated by graph 420 showing P_{PMU}, Q_{PMU}. A second power system component model 430 may receive parameter set θ* and generate P(θ′), Q(θ′) as illustrated by graph 440 showing P_{PMU}, Q_{PMU}. First power system component model 410 and second power system component model 430 may, e.g., implement a model associated with PSLF and/or TSAT.

A dynamic model device in accordance with an embodiment may implement the following model as shown below:

$$Model \text{:} y ( θ ) = [ \begin{matrix}P ( θ ) \\ Q ( θ )\end{matrix} ] , Measurement \text{:} {y}^{m} = [ \begin{matrix}{P}_{P M U} \\ {Q}_{P M U}\end{matrix} ] ,$$

where, P(θ), Q(θ) are model outputs as a function of parameter set θ and P_{PMU} and Q_{PMY} are time series PMU measurements. A goal of model calibration may be to find a parameter set θ* such that model output matches measurements: y(θ)≈y^{m}. According to one or more embodiments, a two-stage approach may include:
(a) Stage 1 including parameter identifiability analysis; and
(b) Stage 2 including parameter estimation.

In an embodiment, there may be 60-120 parameters within a parameter set parameter set θ. Accordingly, during Stage 1, parameters from parameter set θ may be identified and the parameters may subsequently be estimated during Stage 2.

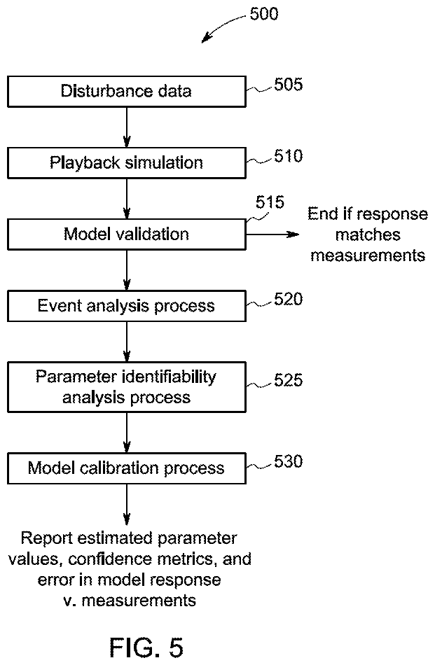

FIG. 5 illustrates a general framework of a process 500 for power system model parameter conditioning according to some embodiments. At operation 505, disturbance data may be obtained (e.g., from a PMU or DFR) to obtain, for example, V, f, P, and Q measurement data at a Point of Interest (“POI”). At operation 510, a playback simulation may run load model benchmarking using default model parameters (e.g., associated with PSLF and/or TSAT). At operation 515, a model validation operation may compare measurements to a default model response. If the response matches the measurements, the process 500 may end (e.g., a determination may be made that the existing model is sufficiently accurate or correct and does not need to be updated). At operation 520, an event analysis process may determine whether an event is qualitatively different from previous events. At operation 525, a parameter identifiability analysis process may determine a most identifiable set of parameters across all events of interest. Finally, at operation 530, an Unscented Kalman Filter (“UKF”)/optimization-based parameter estimation process may be performed. As a result, estimated parameter values, confidence metrics, and an error in a model response (aa compared to measurements) may be reported, for example.

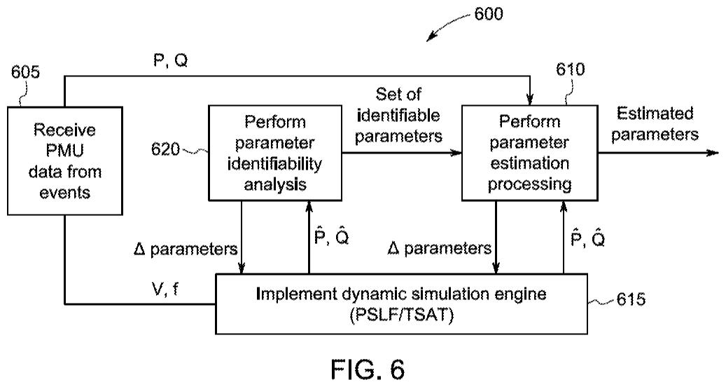

FIG. 6 illustrates a block diagram of an embodiment 600 model calibration process for a two-stage approach. As illustrated, PMU measurements or data from events may be received at operation 605 and may be provided to perform parameter estimation processing at operation 610 and may also be provided to a dynamic simulation engine (PSLF/TSAT) at operation 615. For example, a dynamic simulation engine may perform various calculations on PSLF and TSAT at operation 615.

Referring back to FIG. 3, the most comprehensive load model is WECC Composite load model, denoted as “cmpldw” in General Electric®'s PSLF software. There are more than 100 parameters in this model, as shown below in Tables 1-4. Table 1 and Table 2 show aggregated load model parameters covering information of feeder, transformer and fractions of each load type. Table 3 shows parameters for a Type 3 motor and Table 4 shows parameters for Type 1 A/C load.

TABLE 1
Model parameters in WECC Composite load model - Part 1

| | Default | |
|---|---|---|
| Parameter | Value | Description |
| Pmin | 0 | Minimum load P, MW |
| PQmin | 0 | Minimum load P/Q ratio |
| Vmin | 0 | Minimum bus voltage, p.u. |
| Bss | 0 | Substation shunt capacitor susceptance, p.u. |
| Rfdr | 0 | Feeder equivalent resistance, p.u. |
| Xfdr | 0 | Feeder equivalent reactance, p.u. |
| Fb | 0 | Fraction of feeder shunt capacitance at substation |
| | | bus end |
| Xxf | 0 | Substation transformer reactance, p.u. |
| Tfixhs | 1 | Transformer high side fixed tap, p.u. |
| Tfixls | 1 | Transformer low side fixed tap, p.u. |
| LTC | 0 | =1 for automatic tap adjustment (low side |
| | | variable tap) |
| Tmin | 0.9 | Minimum variable tap, p.u. |
| Tmax | 1.1 | Maximum variable tap, p.u. |
| step | 0.00625 | Variable tap step size, p.u. |
| Vmin | 1.02 | Minimum low-side voltage, p.u. |
| Vmax | 1.04 | Maximum low-side voltage, p.u. |
| Tdel | 30 | Time delay to initiate tap adjustment, sec. |
| Ttap | 5 | Time delay between tap steps, sec. |
| Rcmp | 0 | Transformer LTC compensating resistance, p.u. |
| Xcmp | 0 | Transformer LTC compensating reactance, p.u. |

TABLE 2
Model parameters in WECC Composite load model - Part 2

| | Default | |
|---|---|---|
| Parameter | Value | Description |
| FmA | 0 | Motor A fraction of load P |
| FmB | 0 | Motor B fraction of load P |
| FmC | 0 | Motor C fraction of load P |
| FmD | 0 | Motor D fraction of load P |
| Fel | 0 | Electronic load fraction of load P |
| PFel | 0 | Electronic load power factor |
| Vd1 | 0 | Voltage below which electronic load decreases, p.u. |
| Vd2 | 0 | Voltage below which electronic load is zero, p.u. |
| frcel | 0 | Fraction of electronic load that recovers from |
| | | low voltage trip |
| PFs | 0.8 | Power factor of static load component |
| P1e | 1 | Static load - exponent of first P term |
| P1c | 1 | Static load - coefficient of first P term |
| P2e | 2 | Static load - exponent of second P term |
| P2c | 0 | Static load - coefficient of second P term |
| Pfrq | 0 | Frequency sensitivity factor for P |
| Q1e | 1 | Static load - exponent of first Q term |
| Q1c | 0 | Static load - coefficient of first Q term |
| Q2e | 2 | Static load - exponent of second Q term |
| Q2c | 1 | Static load - coefficient of second Q term |
| Qfrq | 0 | Frequency sensitivity factor for Q |
| Mtypa | 0 | First motor type: =3 -- three-phase motor; =1 -- |
| | | 1-phase air conditioner |
| Mtypb | 0 | Second motor type |
| Mtypc | 0 | Third motor type |
| Mtypd | 0 | Fourth Motor type |

TABLE 3
Model parameters in WECC Composite load model - Part 3

| | Default | |
|---|---|---|
| Parameter | Value | Description |
| LFmn | 0.8 | Motor loading factor |
| Rsn | 0.02 | Stator resistance, p.u. |
| Lsn | 2 | Ssynchronous reactance, p.u. |
| Lpn | 0.2 | Transient reactance, p.u. |
| Lppn | 0.2 | Subtransient reactance, p.u. |
| Tpon | 0.16 | Transient open circuit time constant, sec. |
| Tppon | 0.02 | Subtransient open circuit time constant, sec. |
| Hn | 0.3 | Inertia constant, sec. |
| Etrqn | 2 | Mechanical torque exponent |
| Vtr1n | 0 | First low voltage trip level, p.u. V |
| Ttr1n | 9999 | First low voltage trip delay time, sec. |
| Ftr1n | 0 | First low voltage trip fraction |
| Vrc1n | 9999 | First low voltage reconnection level, p.u. V |
| Trc1n | 9999 | First low voltage reconnection delay time, sec. |
| Vtr2n | 0 | Second low voltage trip level, p.u. V |
| Ttr2n | 9999 | Second low voltage trip delay time, sec. |
| Ftr2n | 0 | Second low voltage trip fraction |
| Vrc2n | 9999 | Second low voltage reconnection level, p.u. V |
| Trc2n | 9999 | Second low voltage reconnection delay time, sec. |

TABLE 4
Model parameters in WECC Composite load model - Part 4

| | Default | |
|---|---|---|
| Parameter | Value | Description |
| LFmn | 1 | Motor loading factor |
| CompPFn | 0.97 | Power factor |
| Vstalln | 0.6 | Stall voltage, p.u. |
| Rstalln | 0.124 | Stall resistance, p.u. |
| Xstalln | 0.114 | Stall reactance, p.u. |
| Tstalln | 0.033 | Stall time delay, sec. |
| Frstn | 0.5 | Fraction of load that can restart after stalling |
| Vrstn | 0.6 | Voltage at which restart can occur, p.u. |
| Trstn | 0.4 | Restart time delay, sec. |
| Fuvrn | 0 | Fraction of load with undervoltage relay protection |
| Vtr1n | 0 | First undervoltage trip level, p.u. |
| Ttr1n | 0.2 | First undervoltage trip delay time, sec. |
| Vtr2n | 0 | Second undervoltage trip level, p.u. |
| Ttr2n | 5 | Second undervoltage trip delay time, sec. |
| Vc1offh | 0.5 | Contactor voltage at which tripping starts, p.u. |
| Vc2offh | 0.4 | Contactor voltage at which tripping is complete p.u. |
| Vc1onn | 0.6 | Contactor voltage at which reconnection is |
| | | complete, p.u. |
| Vc2onn | 0.5 | Contactor voltage at which reconnection starts, p.u. |
| Tthn | 20 | Thermal time constant, sec. |
| Th1tn | 0.7 | Thermal protection trip start level, p.u. temperature |
| Th2tn | 1.3 | Thermal protection trip completion level, p.u. |
| | | temperature |
| Tvn | 0.05 | Voltage measurement lag, sec. |

A goal of load modeling is to identify the true value for these parameters based on measurement data. However, consideration of so many parameters poses great challenge in parameter estimation as known by the practitioners in this area. On the other hand, a lot of parameters are not likely to change with measurement. Accordingly, referring again to FIG. 6, a parameter identifiability analysis 620 may therefore be performed to determine a set of identifiable parameters across a range of events and default values. A series of playback simulations with perturbation on each parameter may be conducted, and those parameter with higher impact on the simulated response may be selected for use in parameter estimation module 610. Candidate parameter estimation algorithms implemented at operation 610 may include, for example, an Unscented Kalman Filter (UKF) and an Optimization-based Calibration. Both calibration techniques may, for example, be performed with minimal information from a dynamic simulation engine implementing PSLF/TSAT at operation 615.

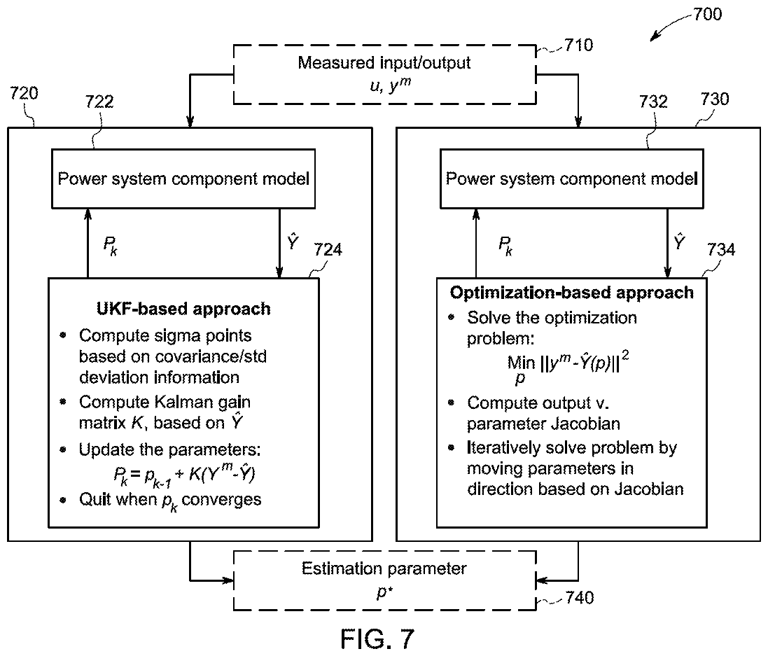

FIG. 7 illustrates candidate parameter estimation algorithms 700 according to an embodiment. In one approach 720, measured input/output data 710 (u, y^{m}) may be used by a power system component model 722 may comprise an Unscented Kalman Filter (UKF) based approach 724 to create an estimation parameter (p*) 740. In particular, the system may compute sigma points based on covariance and standard deviation information. The Kalman Gain matrix K may be computed based on Ŷ and the parameters may be updated based on:

pₖ=pₖ₋₁+K(y^{m}−ŷ) [Relation 3]

until pₖ converges. According to another approach 730, the measured input/output data 710 (u, y^{m}) may be used by a power system component model 732 and an optimization-based approach 734 to create the estimation parameter (p*) 740. In this case, the following optimization problem may be solved:

$${min}_{p} {‖ {y}^{m} - \hat{Y} ( p ) ‖}^{2} \qquad [ Relation 4 ]$$

The system may then compute an output as compared to parameter Jacobian information and iteratively solve the above optimization problem by moving parameters in directions indicated by the Jacobian information.

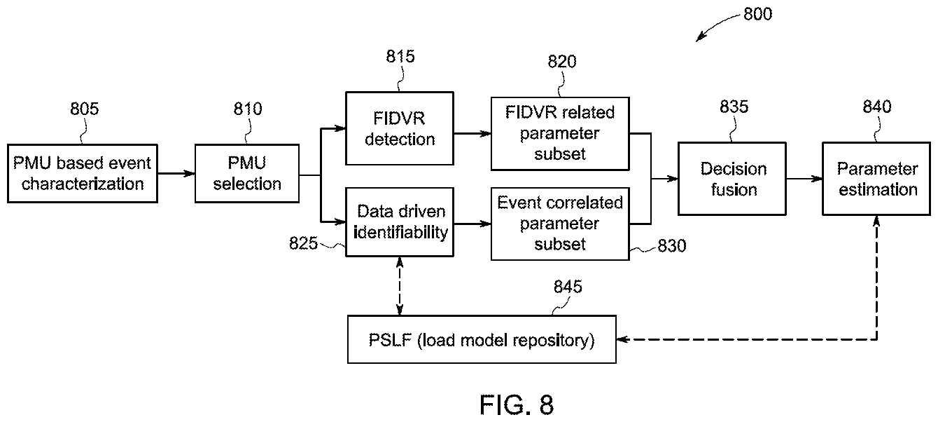

FIG. 8 is a block diagram of an embodiment 800 a system for modeling one or more dynamic devices of an electric power system. At block 805, PMU-based event characterization may be performed, wherein the power grid event is detected, analyzed and correlated with one or multiple PMU at various location of the power grid. At block 810, PMU selection may be performed.

An embodiment for blocks 805 and 810 may comprise an Enhanced Disturbance Management (EDM) component (e.g., module) that is operable to read (e.g., obtain) monitoring data, for example, Supervisory Control and Data Acquisition (SCADA) system data, PMU-based data, topology data, and the like, based on power flow measurements associated with measurement devices (e.g., PMUs, current sensors, voltage sensors, etc.) connected to an electrical power system (e.g., electric power system, electrical energy system, electric energy system, power grid system, etc.), where the monitoring data may comprise alarm data indicative of an electrical disturbance within an electrical power system, and topology data indicative of a topology of the electrical power system. The EDM component may be operable to correlate the alarm data, which may relate to, for example, an angle disturbance alarm, or, for example, a frequency disturbance alarm, with a change in the topology data.

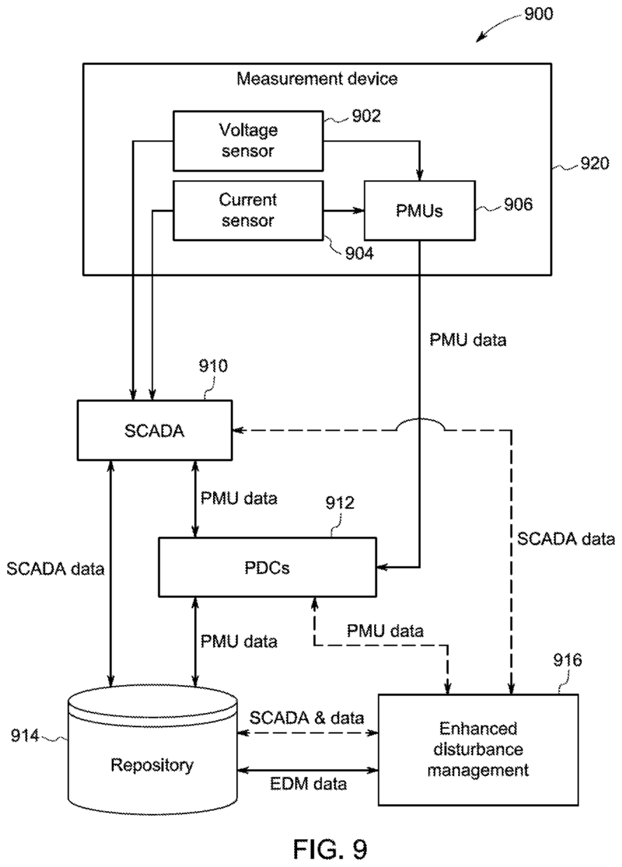

FIG. 9 illustrates a power grid system 900 including an EDM module 916 in accordance with an example embodiment. In this example, the EDM module 916 may determine a characterization (e.g., classification, causation) of the electrical disturbance in the power grid system based on the correlating of the alarm data with the topology data, determining a coherency level representative of the degree of correlation between the alarm data and the topology data, determining a Disturbance Impact Factor (DIF) indicative of an impact of the electrical disturbance on a location in the power grid system, and identify one or more sensors (PMUs) that have captured data of the disturbance. The EDM module 916 may further auto-map PMUs to one or more power system nodes on the grid, retrieve power model information of the power system nodes, and validate the retrieved power model based on the PMU information of the disturbance. In some embodiments, the EMD module 916 may also store and display disturbance history, event history, and a variety of other statistical information related to disturbances and events, including on a graphical user interface, or in a generated report.

A measurement device 920 shown in FIG. 9 may obtain, monitor or facilitate the determination of electrical characteristics associated with the power grid system (e.g., the electrical power system), which may comprise, for example, power flows, voltage, current, harmonic distortion, frequency, real and reactive power, power factor, fault current, and phase angles. Measurement device may also be associated with a protection relay, a Global Positioning System (GPS), a Phasor Data Concentrator (PDC), communication capabilities, or other functionalities.

Measurement devices may provide real-time measurements of electrical characteristics or electrical parameters associated with the power grid system (e.g., the electrical power system). The measurement device may, for example, repeatedly obtain measurements from the power grid system (e.g., the electrical power system) which may be used by the EDM module 916. The data generated or obtained by the measurement device may be coded data (e.g., encoded data) associated with the power grid system that may input (or be fed into) a traditional SCADA/EMS system. The measurement device may also be a PMU that repeatedly obtains subs-second measurements (e.g., 30 times per second). Here, the PMU data may be fed into, or input into, applications (e.g., Wide Area Monitoring System (WAMS) and WAMS-related applications) that may utilize the more dynamic PMU data (explained further below).

In the example of FIG. 9, the measurement device 920 includes a voltage sensor 902 and a current sensor 904 that feed data typically via other components, to, for example, a Supervisory Control and Data Acquisition (SCADA) system (e.g., SCADA component 910). Voltage and current magnitudes may be measured and reported to a system operator every few seconds by the SCADA component 910. The SCADA component 910 may provide functions such as data acquisition, control of power plants, and alarm display. The SCADA component may also allow operators at a central control center to perform or facilitate management of energy flow in the power grid system. For example, operators may use a SCADA component (for example using a computer such as a laptop or desktop) to facilitate performance of certain tasks such opening or closing circuit breakers, or other switching operations that might divert the flow of electricity.

In some examples, the SCADA component 910 may receive measurement data from Remote Terminal Units (RTUs) connected to sensors in the power grid system, Programmable Logic Controllers (PLCs) connected to sensors in the power grid system, or a communication system (e.g., a telemetry system) associated with the power grid system. PLCs and RTUs may be installed at power plants, substations, and the intersections of transmission and distribution lines, and may be connected to various sensors, including the voltage sensor 902 and the current sensor 904. The PLCs and RTUs receive its data from the voltage and current sensors to which they are connected. The PLCs and RTUs may convert the measured information to digital form for transmission of the data to the SCADA component. In example embodiments, the SCADA component 910 may also comprise central host server or servers called master terminal units (MTUs), sometimes also referred to as a SCADA center. The MTU may also send signals to PLCs and RTUs to control equipment through actuators and switchboxes. In addition, the MTU may perform controlling, alarming, and networking with other nodes, etc. Thus, the SCADA component 910 may monitor the PLCs and RTUs and may send information or alarms back to operators over telecommunications channels.

The SCADA component 910 may also be associated with a system for monitoring or controlling devices in the power grid system, such as an Energy Management System (EMS). An EMS may comprise one or more systems of computer-aided tools used by operators of the electric power grid systems to monitor, control, and optimize the performance of the generation or transmission system. Often, an EMS is also referred to as SCADA/EMS or EMS/SCADA. In these respects, the SCADA/EMS or EMS/SCADA may also perform the functions of a SCADA. Or, a SCADA may be operable to send data (e.g., SCADA data) to the EMS, which may in turn provide the data to the EDM module 916. Other systems with which the EDM module 916 may be associated may comprise a situational awareness system for the power grid system, a visualization system for the power grid system, a monitoring system for the power grid system or a stability assessment system for the power grid system.

The SCADA component 910 may generate or provide SCADA data (e.g., SCADA DATA shown in FIG. 9) comprising, for example, real-time information (e.g., real-time information associated with the devices in the power grid system) or sensor information (e.g., sensor information associated with the devices in the power grid system) that may be used by the EDM module 916. The SCADA data may be stored, for example, in a repository 914 (described further below). In example embodiments, data determined or generated by the SCADA component 910 may be employed to facilitate generation of topology data (topology data is further described below) that may be employed by the EDM module 916 for enhanced disturbance management, which is further described below.

The employment of current sensor 904 and voltage sensor 902 allow for fast response. Traditionally, the SCADA component 910 monitors power flow through lines, transformers, and other components relies on the taking of measurements every two to six seconds, but cannot be used to observe the dynamic characteristics of the power system because of its slow sampling rate (e.g., cannot detect the details of transient phenomena that occur on timescales of milliseconds (one 60 Hz cycle is 16 milliseconds). Additionally, although SCADA technology enables some coordination of transmission among utilities, the process may be slow, especially during emergencies, with much of the response based on telephone calls between human operators at the utility control centers. Furthermore, most PLCs and RTUs were developed before industry-wide standards for interoperability were established, and as such, neighboring utilities often use incompatible control protocols.

The measurement device also includes one or more PMUs 906. A PMU 906 may be a standalone device or may be integrated into another piece of equipment such as a protective relay. PMUs 906 may be employed at substations, and may provide input into one or more software tools (e.g., WAMS, SCADA, EMS, and other applications). A PMU 906 may use voltage and current sensors (e.g., voltage sensors 902, current sensors 904) that may measure voltages and currents at principal intersecting locations (e.g., substations) on a power grid using a common time source for synchronization, and may output accurately time-stamped voltage and current phasors. The resulting measurement is often referred to as a synchrophasor (although the term “synchrophasor” refers to the synchronized phasor measurements taken by the PMU 906, some have also used the term to describe the device itself). Because these phasors are truly synchronized, synchronized comparison of two quantities is possible in real time, and this time synchronization allows synchronized real-time measurements of multiple remote measurement points on the grid.

In addition to synchronously measuring voltages and currents, phase voltages and currents, frequency, frequency rate-of-change, circuit breaker status, switch status, etc., the high sampling rates (e.g., 30 times a second) provides “sub-second” resolution in contrast with SCADA-based measurements. These comparisons may be used to assess system conditions such as: frequency changes, power in megawatts (MW), reactive power in mega volt ampere reactive (MVARs), voltage in kilovolts (KV), etc. As such, PMU measurements may provide improved visibility into dynamic grid conditions and may allow for real-time wide area monitoring of power system dynamics. Further, synchrophasors account for the actual frequency of the power delivery system at the time of measurement. These measurements are important in alternating current (AC) power systems, as power flows from a higher to a lower voltage phase angle, and the difference between the two relates to power flow. Large phase angle differences between two distant PMUs may indicate the relative stress across the grid, even if the PMUs are not directly connected to each other by a single transmission line. This phase angle difference may be used to identify power grid instability, and a PMU may be used to generate an angle disturbance alarm (e.g., angle difference alarm) when it detects a phase angle difference.

Examples of disturbances that might cause the generation of an angle disturbance alarm may comprise, for example, a line out or line in disturbance (e.g., a line out disturbance in which a line that was in service has now gone out of service, or in the case of a line in disturbance, in which case a line that was out of service has been brought back into service). PMUs 906 may also be used to measure and detect frequency differences, resulting in frequency alarms being generated. As an example, unit out and unit in disturbances may result in the generation of a frequency alarm (e.g., a generating unit was in service, but might have gone out of service, or a unit that was out of service has come back in to service—both may cause frequency disturbances in the system that may result in the generation of a frequency alarm.). Still yet, PMUs 906 may also be used to detect oscillation disturbances (e.g., oscillation in the voltage, frequency, real power—any kind of oscillation), which may result in the generation of an alarm (e.g., oscillation alarm). Several other types of alarms may be generated based on PMU data from PMU based measurements. Although the disturbances mentioned (e.g., line in/out, unit in/out, load in/out) may result in angle or frequency disturbance alarms, an angle or frequency disturbance alarm might not necessarily mean that a particular type of disturbance occurred, only that it is indicative of that type of disturbance. For example, if a frequency disturbance alarm is detected, it might not necessarily be a unit in or unit out disturbance, but may be a load in or load out disturbance. The measurement requirements and compliance tests for a PMU 906 have been standardized by the Institute of Electrical and Electronics Engineers (IEEE), namely IEEE Standard C37.118.

In the example of FIG. 9, one or more Phasor Data Concentrators (PDCs) 912 are shown, which may comprise local PDCs at a substation. Here, PDCs 912 may be used to receive and time-synchronized PMU data from multiple PMUs 906 to produce a real-time, time-aligned output data stream. A PDC may exchange phasor data with PDCs at other locations. Multiple PDCs may also feed phasor data to a central PDC, which may be located at a control center. Through the use of multiple PDCs, multiple layers of concentration may be implemented within an individual synchrophasor data system. The PMU data collected by the PDC 912 may feed into other systems, for example, a central PDC, corporate PDC, regional PDC, the SCADA component 910 (optionally indicated by a dashed connector), energy management system (EMS), synchrophasor applications software systems, a WAMS, the EDM module 916, or some other control center software system. With the very high sampling rates (typically 10 to 60 times a seconds) and the large number of PMU installations at the substations that are streaming data in real time, most phasor acquisition systems comprising PDCs are handling large amounts of data. As a reference, the central PDC at Tennessee Valley Authority (TVA), is currently responsible for concentrating the data from over 90 PMUs and handles over 31 gigabytes (GBs) of data per day.

In this example, the measurement device , the SCADA component 910, and PDCs/Central PDCs 912, may provide data (e.g., real-time data associated with devices, meters, sensors or other equipment in the power grid system) (including SCADA data and topology data), that may be used by the EDM module 916 for enhanced disturbance management. Both SCADA data and PMU data may be stored in one or more repositories 914. In some example embodiments, the SCADA data and PMU data may be stored into the repository 914 by the SCADA component 910, or by the PDC 912. In other embodiments, the EDM module 916 may have one or more components or modules that are operable to receive SCADA data and PMU data and store the data into the repository 914 (indicated by dashed lines). The repository may comprise a local repository, or a networked repository. The data on the repository 914 may be accessed by SCADA component 910, the PDCs 912, other systems (not shown), and optionally by example embodiments of the EDM module 916. In example embodiments, the EDM module 916 may be operable to send instructions to one or more other systems (e.g., SCADA component 910, PDCs 912) to retrieve data stored on the repository 914 and provide it to the EDM module 916. In other embodiments, the EDM module 916 may facilitate retrieval of the data stored in repository 914, directly.

In example embodiments, the data stored in the repository 914 may be associated SCADA data and PMU data. The data may be indicative of measurements by measurement device that are repeatedly obtained from a power grid system. In example embodiments, the data in repository 914 may comprise PMU/SCADA-based equipment data, such as, for example, data associated with a particular unit, line, transformer, or load within a power grid system (e.g., power grid system 900). The data may comprise voltage measurements, current measurements, frequency measurements, phasor data (e.g., voltage and current phasors), etc. The data may be location-tagged. For example, it may comprise a station identification of a particular station in which a power delivery device being measured is located (e.g., “CANADA8”). The data may comprise a particular node number designated for a location. The data may comprise the identity of the measure equipment (e.g., the identification number of a circuit breaker associated with an equipment). The data may also be time-tagged, indicating the time at which the data was measured by a measurement device. The PMU/SCADA-based equipment data may also contain, for example, information regarding a particular measurement device (e.g., a PMU ID identifying the PMU from which measurements were taken).

In example embodiments, the data stored in repository 914 may comprise not only collected and measured data from various measurement devices , the data may also comprise data derived from that collected and measured data. The data derived may comprise topology data (e.g., PMU/SCADA-based topology data), event data, and event analysis data, and EDM data (data generated by EDM module 916).

In example embodiments, the repository 914 may contain topology data (e.g., PMU/SCADA-based topology data) indicative of a topology for the power grid system 900. The topology of a power grid system may relate to the interconnections among power system components, such as generators, transformers, busbars, transmission lines, and loads. This topology may be obtained by determining the status of the switching components responsible for maintaining the connectivity status within the network. The switching components may be circuit breakers that are used to connect (or disconnect) any power system component (e.g., unit, line, transformer, etc.) to or from the rest of the power system network. Typical ways of determining topology may be by monitoring of the circuit breaker status, which may be done using measurement devices and components associated with those devices (e.g., RTUs, SCADA, PMUs). It may be determined as to which equipment has gone out of service, and actually, which circuit breaker has been opened or closed because of that equipment going out of service.

The topology data may be indicative of an arrangement (e.g., structural topology, such as radial, tree, etc.) or a power status of devices in the power grid system. Connectivity information or switching operation information originating from one or more measurement devices may be used to generate the topology data. The topology data may be based on a location of devices in the power grid system, a connection status of devices in the power grid system or a connectivity state of devices in the power grid system (e.g., devices that receive or process power distributed in throughout the power grid system, such as transformers and breakers). For example, the topology data may indicate where devices are located, and which devices in the power grid system are connected to other devices in the power grid system (e.g., where devices in the power grid system are connected, etc.) or which devices in the power grid system are associated with a powered grid connection. The topology data may further comprise the connection status of devices (e.g., a transformer, etc.) that facilitate power delivery in the power grid system, and the statuses for switching operations associated with devices in the power grid system (e.g., an operation to interrupt, energize or de-energize or connect or disconnect) a portion of the power grid system by connecting or disconnecting one or more devices in the power grid system (e.g., open or close one or more switches associated with a device in the power grid system, connect or disconnect one or more transmission lines associated with a device in the power grid system etc.). Furthermore, the topology data may provide connectivity states of the devices in the power grid system (e.g., based on connection points, based on busses, etc.).

In example embodiments, the repository 914 may contain a variety of event and event analysis data, which may be derived based on PMU data, and in some embodiments, other data as well (e.g., SCADA data, other measurement data, etc.). The data may comprise information regarding events related to the power grid system 900. An event may comprise, for example, one or more disturbances to the power grid system. A disturbance may comprise, for example, a line disturbance (e.g., line in, or line out), a unit disturbance (e.g., unit in or unit out), or load disturbance (load in or load out). For each event, relevant information such as the station where the event occurred, the voltage level associated with the station (e.g., 500 kV), the node number related to the event, the equipment related to the event, the change in real and reactive power, and change in voltage per unit for the event. The event and event analysis data may also comprise EDM data, which may be data related to events. The various data stored in the repository 914, including equipment data, topology data, event data, event analysis data, EDM data, and other data, may be inputs into the various functionalities and operations that may be performed by the EDM module 916.

Referring back to FIG. 8, at block 815, FIDVR event detection may be performed to detect and flag an FIDVR event approximately in real time based on voltage measurement, for example. A particular embodiment may utilize a calculation of Kullback-Leibler Divergence between probability distributions of delayed voltage response and a reference waveform. Another embodiment may utilize an on-line extreme learning machine, or neural network, to identify an FIDVR event based on PMU measurements or other data. An additional embodiment may utilize a rule-based approach, such as Measure duration, percentage reduction in voltage, and/or Flag FIDVR, for example, when such indices cross preset thresholds, for example. Blocks 805, 810, and 815 may be performed via Artificial Intelligence (AI), for example.

In accordance with an embodiment, after an FIDVR event has been detected or identified, an FIDVR-induced parameter set may be determined, such as automatically, at operation 820. The FIDVR-induced parameter set may include, for example, Fraction of 1-ph motor (FmD), Thermal protection related (with a Time constant Tth, trip start Th1t, and completion level Th2t, Stall related (Vstall, Rstall, Xstall, Tstall)) and/or other parameters such as fractions of 3-phase motors or a ZIP load, to name just a few examples among many.

At block 825, data driven parameter identifiability may be performed to generate a trajectory sensitivities matrix for an electrical power system using a dynamic model of the electrical power system that includes a plurality of system parameters.

Two embodiments for parameter identifiability are singular-value decomposition (SVD) based approach and Dot Product Angle (DPA) based approach.

“SVD,” as used herein, refers to a matrix decomposition method for reducing a matrix to its constituent parts. For example, by reducing a matrix to its constituent parts, certain subsequent matrix calculations may be simplified. For example, SVD comprises a factorization of a real or complex matrix. SVD comprises a generalization of an eigendecomposition of a positive semidefinite normal matrix (e.g., a symmetric matrix with positive eigenvalues) to any m x n matrix via an extension of polar decomposition. SVD has many useful applications in signal processing and statistics, for example.

“DPA,” as used herein, refers to an algebraic operation that takes two equal-length sequences of numbers, such as, e.g., coordinate vectors, and returns a single number. In Euclidean geometry, a dot product of Cartesian coordinates of two vectors commonly used and is often referred to as “the” inner product (or rarely projection product) of Euclidean space even though it is not the only inner product that can be defined on Euclidean space. Algebraically, ae dot product is the sum of the products of the corresponding entries of the two sequences of numbers. Geometrically, it is the product of the Euclidean magnitudes of the two vectors and the cosine of the angle between them. These definitions are equivalent when using Cartesian coordinates. In modern geometry, Euclidean spaces are often defined by using vector spaces. In this case, the dot product is used for defining lengths (e.g., the length of a vector is the square root of the dot product of the vector by itself) and angles (e.g., the cosine of the angle of two vectors is the quotient of their dot product by the product of their lengths).

In one particular embodiment, an issue of parameter identifiability may be considered or addressed. For example, a relatively simple linear 2-parameter estimation problem may comprise:

$$y = C [ \begin{matrix}{θ}_{1} \\ {θ}_{2}\end{matrix} ] , with C = [ \tilde{c} \tilde{c} ] ⇒ y = \tilde{c} ( {θ}_{1} + {θ}_{2} ) \qquad [ Relation 5 ]$$

In Relation 5, if (θ*₁+θ*₂) is a true solution (\tilde{c}(θ*₁+θ*₂)=y^{m}), then any (θ*₁−δ, θ*₂+δ) equally explain the measurements, for example. A failure to identify parameters uniquely may be due to a rank deficiency of output matrix C.

An analogous quantity n a nonlinear case may comprise a Jacobian matrix as shown below in Relation 6:

$$S = [ \begin{matrix}\frac{\partial P ( {t}_{1} )}{\partial {θ}_{1}} & \frac{\partial P ( {t}_{1} )}{\partial {θ}_{2}} & … & \frac{\partial P ( {t}_{1} )}{\partial {θ}_{k}} \\ \frac{\partial P ( {t}_{2} )}{\partial {θ}_{1}} & \frac{\partial P ( {t}_{2} )}{\partial {θ}_{2}} & … & \frac{\partial P ( {t}_{2} )}{\partial {θ}_{k}} \\ & ⋮ & & \\ \frac{\partial P ( {t}_{N} )}{\partial {θ}_{1}} & \frac{\partial P ( {t}_{N} )}{\partial {θ}_{2}} & … & \frac{\partial P ( {t}_{N} )}{\partial {θ}_{k}} \\ \frac{\partial Q ( {t}_{1} )}{\partial {θ}_{1}} & \frac{\partial Q ( {t}_{1} )}{\partial {θ}_{2}} & … & \frac{\partial Q ( {t}_{1} )}{\partial {θ}_{k}} \\ \frac{\partial Q ( {t}_{2} )}{\partial {θ}_{1}} & \frac{\partial Q ( {t}_{2} )}{\partial {θ}_{2}} & … & \frac{\partial Q ( {t}_{2} )}{\partial {θ}_{k}} \\ & ⋮ & & \\ \frac{\partial Q ( {t}_{N} )}{\partial {θ}_{1}} & \frac{\partial Q ( {t}_{N} )}{\partial {θ}_{2}} & … & \frac{\partial Q ( {t}_{N} )}{\partial {θ}_{k}}\end{matrix} ] \qquad [ Relation 6 ]$$

A rank deficiency of Jacobian matrix S may result from (a) a relatively small number of entries in columns of S; and/or (b) columns of Jacobian matrix S being nearly linearly dependent.

Such factors may show the following, qualitatively: (a) low parameter sensitivity—a successful estimation of that parameter is unlikely because its effect cannot be observed; and/or (b) a nearly linear dependency—a successful estimation of these parameters may therefore be unlikely because of the individual parameter effects.

Moreover, a presence of parameters with weak and/or nearly linearly dependent effects may be reflected as non-unique solutions. Accordingly, it is therefore critical to determine the right set of parameters to be tuned, for example.

In accordance with one particular example of parameter identifiability for multiple events, an average identifiability ranking across disturbances may be calculated. Because sensitivity studies are conducted at the parameters' default values, for example, a parameter conditioning tool may also perform a global sensitivity consistency study when the parameters' values deviate far away from their default values. Such a study may portray a geometry of the parameter sensitivity in the entire parameter space, for example.

Different events may have different characteristics, such that conventional identifiability analysis corresponding to each single event may not be applicable to other events. For example, a set of most-identifiable parameters for event A may not be identifiable for event B. Accordingly, for a single event calibration, the value of this set of parameters may only be tuned by a conventional approach to make the output match event A's measurement data. However, if the tuned parameter values are used to simulate event B, there may still be discrepancy between simulation output from the power system model and measurement data from PMUs.

In accordance with embodiments, because there is availability of measurement data from multiple events, a comprehensive identifiability analysis or study across multiple events may be performed. Such a comprehensive study may provide a most-identifiable parameter set for simultaneous calibration of multiple disturbances. In accordance with embodiments, this parameter set may be used to tune a power system model to better match (as compared to conventionally-tuned power system models) measurement data of multiple events simultaneously.

If a quantity of N events is considered, applying singular-value decomposition (SVD) analysis to the sensitivity trajectory matrices may result in a quantity of null spaces equal to the value of N. The null space for one event also may be interpreted as a system of homogeneous algebraic equations with parameter sensitivities being the unknowns. Because the null space from one event has a rank lower than the number of parameters, the number of equations is less than the number of unknowns.

Considering more events is equivalent to adding more equations to the system. After the event number N exceeds a certain value, the system would have more equations than unknowns. Characteristics of events should be diverse in accordance with an embodiment in order to tune parameters of the system. In an implementation, a numerical rank should be greater than the number of unknowns. A solution which minimizes the difference between the left and right hands of the equation system may represent a comprehensive sensitivity magnitude of all parameters across all the considered events. For sensitivity dependency, accounting for the null spaces of all considered events, a comprehensive dependency index may also be calculated.

In accordance with one or more embodiments, if the number of events is not large enough to construct a null space with higher rank than the number of parameters, the identifiability for each single event may be analyzed, and then the average identifiability may be used as the identifiability across all events.

In accordance with one or more embodiments, a model calibration algorithm may implement Algorithm Ito perform a sensitivity dependency calculation using a null space of the trajectory sensitivity matrix to calculate sensitivity dependency. The dependency index may be defined by counting the large elements in the right singular vectors in null space.

ALGORITHM I

```
procedure DEPENDENCY (NullSpace)
  M ← number of parameters
      N ← number of right singular vectors in null space
      for j ← 1, M do
        Dⱼ ← 0
      end for
      for i ← 1, N do (Search for direct dependencies)
        for j ← 1, M do
            for k ← 1, M do
              if NullSpace(k, i) ≥ threshold then
                  Dⱼ ← Dⱼ ∪ k
              end if
            end for
        end for
      end for
      for j ← 1, M do
        L(j) ← | Dⱼ |
      end for
      k ← 1
    for j ← 1, M do (Search for indirect dependencies)
      while k ≤ L(j) do
            D_{indirect} ← Dⱼ \ D_{Dj(k)}
          if D_{indirect} ≠ 0 then
                Dⱼ ← Dⱼ ∪ D_{indirect}
            L(j) ← L(j) + | D_{indirect} |
            end if
            k ← k + 1
      end while
      end for
end procedure
```

Another parameter identifiability approach is Dot Product Angle (DPA) based approach. Referring back to FIG. 6, performance of a parameter identifiability analysis at operation 620 may analyze parameters to identify potential parameters for use based on the dot product (or scalar product) of the columns of J and r as defined below. In the exemplary embodiment, r comprises a residual which comprises the difference between the measured response data series and the simulated response data series where:

r(θ)=yₜ^{m}−yₜ(θ)

where yₜ^{m} is the measured response of active and reactive power provided in event data, yₜ(x) is the simulated response of active and reactive power based on dynamic simulation engine, including but not limited to, General Electric®'s PSLF, Siemens® PTI's PSS/E, etc. In relation 7, θ represents the model parameters.

An equivalent expression for the above residual is the sum of squares (SOS) objective: ∥r(x)∥₂². The parameter identifiability analysis at operation 620 may use the Quadratic Model (QM) of the objective at (θₖ+d) to approximate the residual at the next step r(θₖ₊₁).

QM(Jₖ, rₖ, d)=∥r(θ)+Jₖd∥₂² [Relation 8]

where Jₖ is the Jacobian vector, which is equal to

$${J}_{k} = \frac{dr}{d θ} {\vert}_{θ k} ,$$

and rₖ=r(θₖ) is the sensitivity result. This leads to:

r(θₖ₊₁)=r(θₖ)+Jₖ(θₖ+d) [Relation 9]

The ultimate goal is to get r(θₖ₊₁) equal to zero. This leads to r(θₖ)=−Jₖ(θₖ+d)

In the exemplary embodiment, the vector r(θₖ) is compared to the Jacobian vector Jₖ to determine the θ between them. In some embodiments, each vector Jₖ may have up to 1000 values each, where the number of values in the Jacobian vector depends on the number of sampling points in the event. The θ is calculated by generating the dot product of the vector r(θₖ) to the Jacobian vector Jₖ.

r(θₖ)*Jₖ=∥r(θₖ)∥ ∥Jₖ∥cos α [Relation 10]

The resulting dot product angle a is compared to a threshold. Parameters with a corresponding α below the threshold are sent to the pool of parameters that are selected. The ideal α is zero, but that is generally unachievable. In some embodiments, any parameter with an angle α of less than 5° is selected by at operation 620 of parameter identifiability analysis. This threshold may be configurable by the user, such as through an interactive user interface. A key idea is that the more orthogonal the angles are between the vectors of J and r, the less likely changes to that parameter moves the response in the desired way. This approach may be extended to a weighted version, by scaling both the measured response and simulated response with a weight vector wₜ. The weight factor wₜ has the same length of the data samples in the event of interest. In this way, given a defined weight factor, it can affect the above calculated dot product angles are between the vectors of J and r, and hence the parameter screening result.

Referring back to FIG. 8, at block 830, an event-correlated parameter subset may be determined or identified, the parameter subset comprising a plurality of well-conditioned parameters for a disturbance from the plurality of system parameters based at least in part on the singular-value decomposition (SVD) based approach and Dot Product Angle (DPA) based approach, for example.

At block 835, decision fusion may be performed to select a final parameter set based, at least in part, on a parameter set determined at block 815 for FIDVR detection and at block 825 for data driven identifiability. Parameter estimation may be performed at box 840. If, for example, a parameter set determined by Identifiability is A, and that from FIDVR is B, a decision fusion method may utilize an intersection of parameter sets A and B, Union of parameter sets A and B, confidence-based selection, Bayesian inference, and/or Dempster-Shafer Inference, for example. At block 845, a PSLF load model repository may interact with box 825 to affect data driven identifiability, and/or with box 840 to affect parameter estimation.

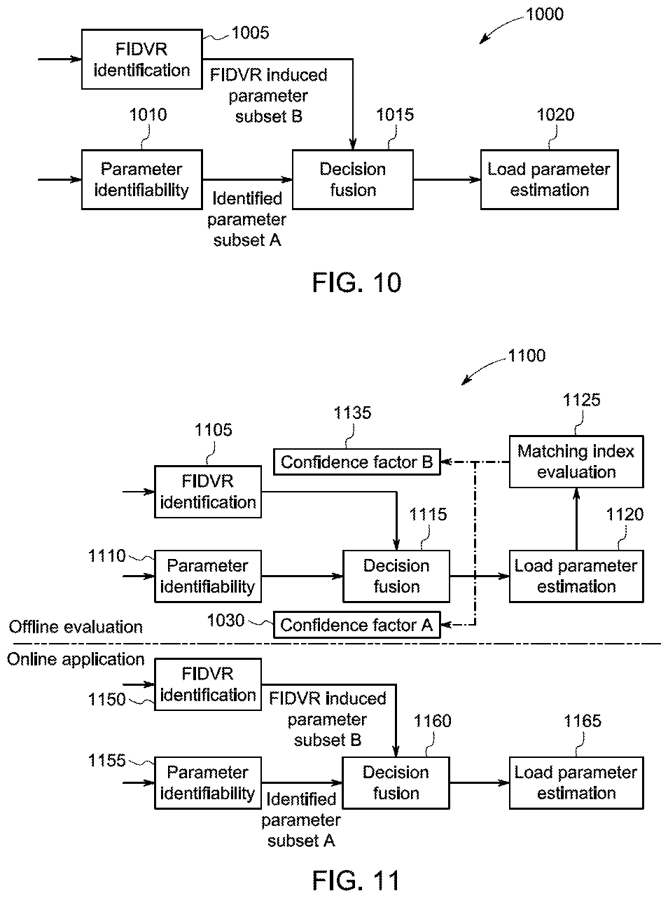

FIG. 10 is an embodiment 1000 of a block diagram of an automatic load model calibration process. For example, embodiment 1000 may provide enhanced parameter sensitivity determination. An automatic load model calibration process in accordance with embodiment 1000 may greatly improve grid reliability, for example, by improving accuracy of load model dynamic response. Power system efficiency may be increased because signature and AI-enabled autonomous model calibration does not need a human-in-the-loop, for example.

In embodiment 1000, block 1005 may perform FIDVR identification, e.g., based on PMU input data, to determine an FIDVR-induced parameter subset B. Block 1010 may perform a parameter identifiability operation, for example, to identify a parameter subset A. A knowledge-based approach may be implemented at block 1010. A knowledge-based approach may implement a form of artificial intelligence (AI), e.g., to capture knowledge of human experts to support decision-making. A knowledge-based approach may utilize a knowledge base and an inference engine, for example. singular-value decomposition (SVD) based approach and Dot Product Angle (DPA) based approach may be used in block 1010. Block 1015 may perform a decision fusion based on the parameters subsets A and B. Block 1020 may perform local parameter estimation, e.g., based on an output from block 1015. A Kalman filtering approach or optimization approach may be used in Block 1020.

FIG. 11 is an embodiment 1100 of a block diagram of an automatic load model calibration process which includes an offline evaluation and an online application. For example, embodiment 1100 may provide enhanced parameter sensitivity determination in accordance with an embodiment.

During an offline evaluation portion, the approach in block 1105 and block 1110 are evaluated and given confidence factor based on their accuracy. The confidence factor may be used for block 1160 in the online application. For example, FIDVR related event data may be acquired at box 1105. A parameter identifiability operation may be performed at box 1110. Outputs of boxes 1105 and 1110 may be provided to box 1115, where a decision fusion operation may be performed. The decision fusion operation at box 1115 may select either parameter subset B or A to independently evaluate a matching index between a modeled response and a measured response, for example. A load parameter estimation operation may be performed at box 1120. The load parameter estimation operation performed at box 1120 may independently evaluate a matching index at box 1125 between a modeled response and a measured response, for example. A confidence factors A and B may be provided from boxes 1130 and 1135, respectively, based on a matching index result, for example.

The matching index at box 1125 may comprise a curve-fitting index comprising mean square errors, Manhattan distance or sum of absolute error, short time series distance, cosine based similarity, correlation coefficient, dynamic time warping, for example, utilized to determine confidence factors A and B.

Mean square errors (MSEs) or a mean squared deviation (MSD) of an estimator (e.g., of a procedure for estimating an unobserved quantity) may measure an average of the squares of errors—that is, the average squared difference between the estimated values and the actual value. MSE is a risk function, corresponding to the expected value of the squared error loss. The fact that MSE is almost always strictly positive (and not zero) is because of randomness or because the estimator does not account for information that could produce a more accurate estimate, for example.

A Manhattan distance comprises a distance between two points measured along axes at right angles. A sum of absolute errors (SAE) comprises a sum of the absolute values of the vertical “residuals” between points generated by a function and corresponding points in the data.

A short time series (STS) distance may comprise a square of the gradient distance between two time series data, for example.

Cosine similarity refers to a measure of similarity between two non-zero vectors of an inner product space that measures the cosine of the angle between them. The cosine of 0° is 1, and it is less than 1 for any angle in the interval (0, π] radians. A cosine similarity is thus a judgment of orientation and not magnitude: two vectors with the same orientation have a cosine similarity of 1, two vectors oriented at 90° relative to each other have a similarity of 0, and two vectors diametrically opposed have a similarity of −1, independent of their magnitude.

A correlation coefficient may comprise a numerical measure of some type of correlation, meaning a statistical relationship between two variables. The variables may comprise two columns of a given data set of observations, e.g., a “sample,” or two components of a multivariate random variable with a known distribution, for example.

Dynamic time warping (DTW) may comprise an algorithm for measuring similarity between two temporal sequences which may vary in speed. For instance, similarities in walking could be detected using DTW, even if one person was walking faster than the other, or if there were accelerations and decelerations during the course of an observation.

During an online application portion of embodiment 1100, FIDVR related event data may be acquired at box 1150. A parameter identifiability operation may be performed at box 1155. Outputs of boxes 1150 and 1155 may be provided to box 1160, where a decision fusion operation may be performed. The decision fusion operation at box 1160 may determine a parameter based on confidence factors A and B evaluated during an offline evaluation phase, as discussed above, for example. Suppose the confidence factor for parameter subset A identifier 1155 is cf1, and confidence factor for subset B identifier 1150 is cf2, then the parameter selection result from 1160 could be a weighted result of A and B based on the confidence factor. C=cf1*A+cf2*B. another example is to select the final parameter subset with the one with higher confidence factor. A load parameter estimation operation may be performed at box 1165.

Various detection algorithms may be utilized for FIDVR detection in 815 of FIG. 8, 905 of FIGS. 9, and 1005 of FIG. 10 in accordance with an embodiment. For example, a diverge detection algorithm may include a K-L divergence of two Probability Distributions Functions (PDF)s of the detected voltage curve and the reference voltage waveform. A reference voltage waveform may be utilized to determine divergence. As also shown, an admittance algorithm may process voltage (V) and current (I) measurements from a PMU and may find a change in admittance of a 1-phase Induction Motor (IM) model, for example. A rule-based detection algorithm may measure duration and percentage reduction in voltage and may flag an FIDVR event when such indices cross preset thresholds, for example. Other detection algorithms may include, for example, discrete cosine transform (DCT), discrete wavelet transform (DWT), slope sequence, shapelet, K-nearest neighbors (KNN), and/or a neural network trained using historical FIDVR measurements.

A Kullback-Leibler (K-L) divergence between probability density function (PDFs) may be analyzed according to an embodiment. An aim or goal may be to implement user-defined models in a real-time test bed and quantify delayed voltage recovery at load bus based on voltage measurement from PMU, for example. A K-L divergence may be utilized between probability distributions of delayed voltage response and reference waveform. A reference waveform may be based on WECC criteria for voltage performance after a fault. A K-L-Index may comprise a statistical-distance between two PDFs. For example, a positive distance may imply an occurrence of an FIDVR event. A moving window may be utilized for real-time monitoring of events, for example.

Various technical advantages may be realized in accordance with an embodiment. For example, because a software tool relies on disturbance data and does not need to take a component offline, the software tool therefore comprises a non-invasive solution and does not result in any interruption of grid operations. Additionally, explicit incorporation of an FIDVR event feature may enhance a quality of identified model parameters, for example, by overcoming drawbacks of a trajectory sensitivity approach. A generic framework may make such a software tool production grade ready to extend from existing generator model calibration to load model calibration.

Such a software tool may also provide various commercial advantages. For example, such a software tool may be sold as an add-on to a Wide Area Management Systems (WAMS) engineering analysis application suite. Additionally, such a software tool may also be sold as an add-on to a PSLF software simulation tool. Utilities, for example, are needed for commercial tools for model validation/calibration and as NERC begins to mandate use of such utilizes on a more stringent basis, the benefits of use of such a tool are increasing.

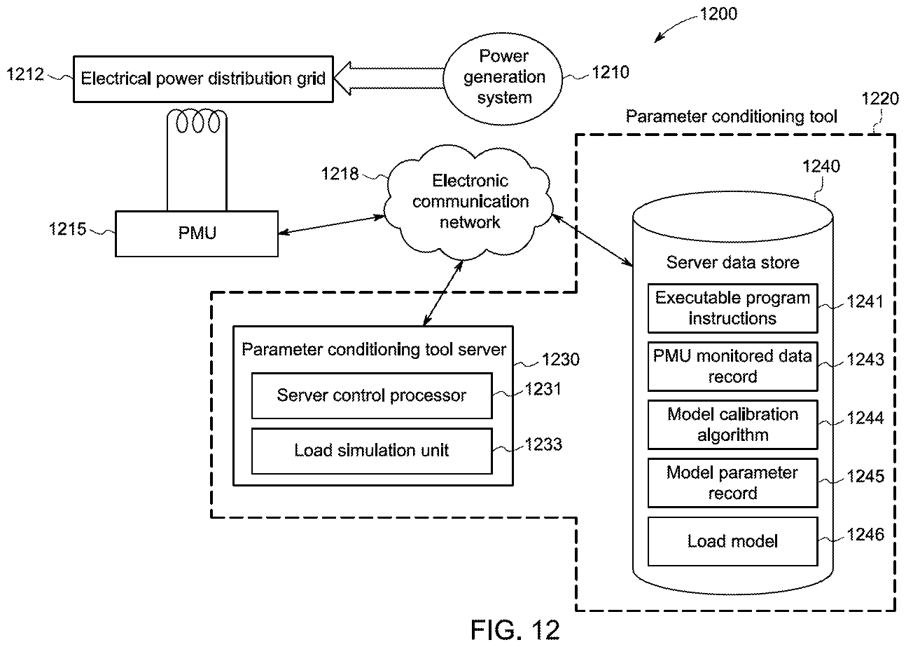

FIG. 12 depicts a system 1200 which includes a power system model parameter conditioning tool in accordance an embodiment. A conditioning tool may improve an accuracy of a load model for various types of dynamic devices drawing power from a grid, for example. In accordance with some embodiments, high-fidelity disturbance measurement data obtained from PMUs for multiple disturbances may be leveraged to improve the load model so that mandated grid reliability requirements can be met.

In accordance with some embodiments, a parameter conditioning tool 1220 may perform analysis using PMU data from one or more faults or events, such as an FIDVR event. This conditioning analysis may tune or optimize parameters in a load model. In accordance with one or more embodiments, the tuning of the at least one parameter may be based on application of a nonlinear least square optimization algorithm, a Kalman filtering estimation algorithm, one or more evolutionary algorithms, a particle swarm optimizer, and/or an artificial immune algorithm, for example.

A non-linear least squares optimization algorithm may be applied to perform a least squares analysis to fit a set of m observations with a model that is non-linear in n unknown parameters, where m≥n. A non-linear least squares optimization algorithm may be used in some forms of nonlinear regression. A basis of a non-linear least squares optimization algorithm is to approximate the model by a linear one and to refine the parameters by successive iterations.

A Kalman filtering estimation algorithm may utilize a series of measurements observed over time, containing statistical noise and other inaccuracies, to generate or produce estimates of unknown variables that tend to be more accurate than those based on a single measurement alone, e.g., by estimating a joint probability distribution over the variables for each timeframe.

An evolutionary algorithm (EA) may comprise a subset of evolutionary computation, such as a generic population-based metaheuristic optimization algorithm. An EA may be utilized within a field of artificial intelligence (AI). An EA may utilize mechanisms inspired by biological evolution, such as reproduction, mutation, recombination, and selection. Candidate solutions to an optimization problem may play the role of individuals in a population, and a fitness function may determine a quality of solutions. Evolution of the population may subsequently occur after repeated application of the above operators.

A particle swarm optimizer may perform a particle swarm optimization (PSO). PSO may comprise a computational method which optimizes a problem by iteratively trying to improve a candidate solution with regard to a given measure of quality. A PSO may solve a problem by having a population of candidate solutions, referred to herein as “particles,” and moving these particles around in a search-space according to simple mathematical formulas over the particle's position and velocity. Each particle's movement is influenced by its local best known position but is also guided toward the best known positions in the search-space, which are updated as better positions are found by other particles. For example, the updated positions are expected to move the swarm toward the best solutions.

An artificial immune algorithm may be implemented by artificial immune systems (AIS) within a field of AI. AIS comprise a class of computationally intelligent, rule-based machine learning systems inspired by principles and processes of the vertebrate immune system. These algorithms are typically modeled after the immune system's characteristics of learning and memory for use in problem-solving.

From the analysis, a set of load model parameters impacted by a fault such as an FIDVR event, or more, may be passed to a load model calibration process or algorithm. The set of parameters may include those load model parameters that are most impacted by the particular selected event(s) (e.g., causing the greatest degradation in power system performance). In accordance with some embodiments, a parametric sensitivity analysis or study may be conducted for differing types of events or disturbances to identify which parameters are to be included in the set, for example.

An embodying model calibration algorithm may tune these passed parameters of the load model to make the outputs generated by the model more closely match the signals collected by the PMUs for the selected disturbances. In some implementations the generated outputs may be, for example, real and reactive power outputs. In accordance with some embodiments, the parameter tuning may consider the effect of multiple events or disturbances to arrive at a global model validation/calibration to best fit a variety of disturbances. In accordance with some embodiments, a calibration step may tune parameters for multiple disturbances simultaneously.

Embodying approaches may account for non-linearity in a load model. Embodying approaches may also account for multiple differing disturbance events. Such approaches may additionally perform calibration of results which may be localized around assumed default parameter values. Physical constraints of parameters may be enforced during model calibration, and an embodying calibration algorithm may avoid tuning model parameters which might already be set at their true (e.g., optimal) values. As shown in FIG. 12, a system 1200 may include a load model parameter conditioning tool 1220 in accordance with some embodiments. An embodying parameter conditioning tool 1220 may include a parameter conditioning tool server 1230 in communication with a server data store 1240.

The server 1230 may include a server control processor 1231 which communicates with other components of the parameter conditioning tool 1220. A server control processor 1231 may access computer executable program instructions 1241, which in some implementations may be stored in a server data store 1240. A server control processor 1231 may support embodying load model parameter conditioning for disturbance-based model validation and/or calibration by executing executable instructions 1241. Dedicated hardware, software modules, and/or firmware may implement embodying approaches disclosed herein.

Server 1230 may be in communication with server data store 1240 directly and/or across an electronic communication network 1218. Electronic communication network 1218 may comprise, or may be part of, an IP network, the Internet, an ISDN, frame relay connections, a modem connected to a phone line, a PSTN, a public or private data network, a LAN, a MAN, a WAN, a wireline or wireless network, a local, regional, or global communication network, an enterprise intranet, any combination of the preceding, and/or any other suitable communication means, for example. It should be recognized that techniques and systems disclosed herein are not limited by the nature of electronic communication network 1218.

A power system may include a power generation system 1210, which provides electrical power to an electrical power distribution grid 1212. A PMU 1215 may be coupled to the electrical power distribution grid to monitor signal characteristics (e.g., voltage (V), frequency (f), active reactive power (P), and nonactive reactive power (Q)). Data obtained by PMU 1215 may be provided to parameter conditioning tool 1220 across electronic communication network 1218. This data may be stored in data records PMU monitored data 1243. It should be readily understood that a power system is not limited to a single power generation system; that an electrical power grid may be a vast, interconnected network of multiple producers (power generation systems), transmission lines, substations, transformers, and loads (power consumers); and that multiple PMUs can be coupled to the power grid at multiple locations.

Under conventional approaches, load model may be tuned (“calibrated”) for one event (e.g., treating each disturbance event separately). This conventional approach results in severely limiting that model's performance to satisfactorily predict a power system's performance in response to a subsequent event. Because some embodiments described herein simultaneously perform power system parameter tuning across multiple events, these system parameters can be provided to a load model 1246. By incorporating the tuned parameters into the load model 1246, the load model 1246 can more accurately predict system performance than conventionally-calibrated (“tuned”) models.

In accordance with some embodiments, the parameter conditioning tool 1220 may generate trajectory sensitivity matrices for all the selected disturbances. These matrices may be generated by perturbing each model parameter and feeding the perturbed parameter values to load simulation unit 1233. Depending on the number of disturbances being considered, model calibration algorithm 1244 can follow two options.

If the number of disturbances is large enough that the union of null spaces of the sensitivity matrices of all the disturbances has a rank higher than the parameter number, an embodying model calibration algorithm 1244 can solve an optimization problem to find a solution that has the minimum total distance to all the null spaces. The solution reflects the parameter set that has dependencies in one or more of these disturbances. Therefore, such a solution gives a comprehensive identifiability ranking of parameters across disturbances.

If the number of disturbances is small, a second option can be implemented by model calibration algorithm 1244. This second option evaluates the identifiability of parameters for each event or disturbance, then calculates the average identifiability ranking across disturbances. Since the sensitivity analyses or studies are conducted at the parameters' default values, the parameter conditioning tool can also perform a global sensitivity consistency study when the parameters' values deviate far away from their default values. Such an analysis or study may portray the geometry of the parameter sensitivity in the entire parameter space.

Since different events, such as FIDVR events, may have different characteristics, the conventional identifiability analysis corresponding to each single event may not be applicable to other events. For example, a set of most-identifiable parameters for event A may not be identifiable for event B. Then, for a single event calibration, the value of this set of parameters is only tuned by a conventional approach to make the output match event A's measurement data. But when the tuned parameter values are used to simulate event B, there could still be discrepancy between simulation output from the load model and measurement data from PMUs.

In accordance with some embodiments, because there is availability of measurement data from multiple events, a comprehensive identifiability study across multiple events can be performed. This comprehensive study can provide a most-identifiable parameter set for the simultaneous calibration of multiple disturbances. In accordance with some embodiments, this parameter set can be used to tune load model 1246 to better match (when compared to conventionally-tuned power system models) the measurement data of multiple events simultaneously.

When a quantity of N events is considered, applying Singular-Value Decomposition (“SVD”) analysis to the sensitivity trajectory matrices results in a quantity of null spaces equal to the value of N. The null space for one event also can be interpreted as a system of homogeneous algebraic equations with parameter sensitivities being the unknowns. Since the null space from one event has a rank lower than the number of parameters, the number of equations is less than the number of unknowns.

Considering more events is equivalent to adding more equations to the system. After the event number N exceeds a certain value (also the characteristic of events should be diverse), the system would have more equations than unknowns. In implementation, the numerical rank should be greater than the number of unknowns. The solution that minimizes the difference between the left and right hand of the equation system represents the comprehensive sensitivity magnitude of all parameters across all the considered events. For sensitivity dependency, accounting for the null spaces of all considered events, a comprehensive dependency index can also be calculated.

In accordance with some embodiments, if the number of events is not large enough to construct a null space with higher rank than the number of parameters, the identifiability for each single event is analyzed, and then the average identifiability can be uses as the identifiability across all events.

In accordance with some embodiments, the model calibration algorithm 1244 may implement an algorithm to perform a sensitivity dependency calculation using null space of the trajectory sensitivity matrix to calculate sensitivity dependency. The dependency index can be defined by counting the large elements in the right singular vectors in null space as shown above in ALGORITHM I.

An approach as discussed herein may provide a model validation/calibration tool for improving models of dynamic devices (e.g., generation plants, renewable energy sources, control devices, and/or dynamic loads, etc.) in electric power systems. As more PMUs and disturbance recorders are installed, an abundance of high-fidelity disturbance measurement data may provide a relatively higher observability of dynamic behavior. One or more embodiments may leverage measurements or other data from grid disturbances for better model accuracy to meet NERC mandated grid reliability requirements, for example.

As will be appreciated based on the foregoing specification, one or more aspects of the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

Some portions of the detailed description are presented herein in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

It should be understood that for ease of description, a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method to generate a power system load model of a power system, the method comprising:
accessing power grid disturbance data;
preparing a power system simulation engine, wherein the simulation engine implements the power system model of the power system;
identifying a parameter subset A from a knowledge-based approach;
identifying the parameter subset B based on a special grid event type based on the power grid disturbance data;
selectively determining a final parameter subset based on parameter subsets A and B using a decision-making approach;
tuning at least one parameter of the final parameter subset; and
modifying one or more parameters of the power system load model based on the tuning.

2. The method of claim 1, wherein the grid event type comprises a Fault-Induced Delayed Voltage Recovery (FIDVR) event.

3. The method of claim 1, wherein the identifying the parameter subset A comprises determining the parameter subset A based on a Jacobian matrix which stores a relative change of simulation response over a relative change of each parameter of the power system model.

4. The method of claim 1, wherein the identifying the parameter subset A is based on application at least one of a Singular Value Decomposition (SVD) method or a Dot Product Angle (DPA) method.

5. The method of claim 4, wherein the identifying the parameter subset A is based on the application of the SVD method comprising transforming the Jacobian matrix into singular values and selecting particular parameters associated with larger singular values for inclusion within parameter subset A.

5. The method of claim 4, wherein the identifying the parameter subset A is based on the application of the DPA method comprising selecting particular parameters of a plurality of parameters based on a score ranking for each of the plurality of parameters based on a DPA score calculated by a Jacobian vector for each of the plurality of parameters and a residual of measured data and simulated response data.

6. The method of claim 1, wherein grid disturbance data is received from one or more phasor measurement units (PMUs) and/or Digital Fault Recorders.

7. The method of claim 1, wherein the tuning of the at least one parameter is based on application of a nonlinear least square optimization algorithm, a Kalman filtering estimation algorithm, one or more evolutionary algorithms, a particle swarm optimizer, and/or an artificial immune algorithm.

8. The method of claim 1, wherein the decision making approach is based on confidence factors for parameter subset A identification and parameter subset B identification during an offline training phase.

9. The method of claim 8, wherein the confidence factors are based on the at least one of a curve fitting index including mean square errors, a Manhattan distance or sum of absolute error, a short time series distance, a cosine based similarity, a correlation coefficient, and/or dynamic time warping.

10. The method of claim 1, wherein the power grid disturbance data comprises at least one parameter comprising at least one measurement of voltage, frequency, angle, active power, or reactive power.

11. A system, comprising:
a receiver to receive power grid disturbance data;
a power system simulation engine, wherein the simulation engine implements a power system load model of a power system;
a processor to:
identify a parameter subset A from a knowledge-based approach;
identify a parameter subset B based on a special grid event type based on the power grid disturbance data;
selectively determine a final parameter subset based on parameter subsets A and B using a decision-making approach;
tuning at least one parameter of the final parameter subset; and
modifying one or more parameters of the power system load model based on the tuning.

12. The system of claim 11, wherein the grid event type comprises a Fault-Induced Delayed Voltage Recovery (FIDVR) event.

13. The system of claim 1, wherein the identification of the parameter subset A comprises a determination of the parameter subset A based on a Jacobian matrix which stores a relative change of simulation response over a relative change of each parameter of the power system load model.

14. The system of claim 11, wherein the receiver is to receive the power grid disturbance data from one or more phasor measurement units (PMUs) and/or Digital Fault Recorders.

15. The system of claim 11, wherein the identification of the parameter subset A is based on application at least one of a Singular Value Decomposition (SVD) method or a Dot Product Angle (DPA) method.

16. The system of claim 15, wherein the identification of the parameter subset A is based on the application of the SVD method comprising transforming the Jacobian matrix into singular values and selection of particular parameters associated with larger singular values for inclusion within parameter subset A.

17. The system of claim 15, wherein the identification of the parameter subset A is based on the application of the DPA method comprising selecting particular parameters of a plurality of parameters based on a score ranking for each of the plurality of parameters based on a DPA score calculated by a Jacobian vector for each of the plurality of parameters and a residual of measured data and simulated response data.

18. An article, comprising:
a non-transitory storage medium comprising machine-readable instructions executable by one or more processors to:
access power grid disturbance data;
prepare a power system simulation engine, wherein the simulation engine implements the power system load model of the power system;
identify a parameter subset A from a knowledge-based approach;
identify the parameter subset B based on a special grid event type based on the power grid disturbance data;
selectively determine a final parameter subset based on parameter subsets A and B using a decision-making approach;
tune at least one parameter of the final parameter subset; and
modify one or more parameters of the power system load model based on the tuning.

19. The article of claim 18, wherein the machine-readable instructions are further executable by the one or more processors to identify the parameter subset A based on an application at least one of a Singular Value Decomposition (SVD) method or a Dot Product Angle (DPA) method.

20. The article of claim 18, wherein the power grid disturbance data is generated by one or more phasor measurement units (PMUs) and/or Digital Fault Recorders.
